(19) United States
(12) Patent Application Publication
(10) Pub. No.: US 2005/0195862 A1
(43) Pub. Date: Sep. 8, 2005

(54) System and method for transparent adjustment of a network node timing component

(75) Inventors: Kenneth R. Jones, Cool, CA (US); Brian A. Gonsalves, Antioch, CA (US); Zesen Chen, Pleasanton, CA (US)

Correspondence Address: TOLER & LARSON & ABEL L.L.P., 5000 PLAZA ON THE LAKE STE 265, AUSTIN, TX, 78746, US

(73) Assignee: SBC Knowledge Ventures, L.P.

(21) Appl. No.: 10/791,212

(22) Filed: Mar. 2, 2004

(51) Int. Cl. H04L 9/00

(52) U.S. Cl. 370/503; 370/350; 713/201

(57) ABSTRACT

A system and method are disclosed for transparent adjustment of a network node timing component. A system incorporating teachings of the present disclosure may include, for example, a housing component at least partially defining an external surface and an internal cavity. A broadband modem component may be at least partially located within the internal cavity along with a home networking mechanism, which may be communicatively coupled to the broadband modem. In operation, the home networking mechanism may facilitate providing a home network node with access to a backhaul enabled by the broadband modem. A processor may also be located within the internal cavity and may be communicatively coupled to the broadband modem and to a memory. In some embodiments, the memory may store instructions that direct the processor to, among other things, embody a web server, receive a timing signal from a remote Public Internet time code protocol server, and communicate time information representing the timing signal to a home network node via the home networking mechanism..

### FIELD OF THE INVENTION

The present disclosure relates generally to managing nodes of an information network, and more specifically to a system and method for transparent adjustment of a network node timing component.

### BACKGROUND

Many consumers maintain multiple electronic devices within their premises. Often, one or more of these devices presents and/or relies on a clock with some timer functionality. For example, a typical home may have a microwave oven and/or a conventional oven that displays a clock. Many of these ovens allow a user to “program” their operation based, at least partially, on the clock. A user may want an oven to turn on and cook a meal for one hour beginning at three o'clock. Effectuating this desire will involve some consideration of the oven's clock.

Other devices within a home may allow for clock dependant operation as well. A videocassette recorder (VCR) or digital video recorder may begin recording at some predetermined time. An alarm clock may output a wake-up signal at some pre-determined time. A thermostat may regulate a home temperature differently at different times of the day. If the home is empty at noon, the thermostat may allow the home to heat up and begin cooling the home at four in the afternoon to ensure that the home is comfortable when the residents return.

Many of the above referenced devices rely on premises power to operate. If electrical power is lost to the premises, these devices may cease operation, and their clocks may lose track of time and begin blinking twelve. If this happens, a user may need to move from device to device—resetting the clocks. This may also occur in geographic areas that recognize daylight savings time. Whatever the cause, many devices providing some level of programmable operation may not allow for time-based programming until their clocks have been reset. And, the act of resetting may be overly complicated for some of these devices.

Moreover, many of these devices include a display presenting what an individual device considers to be the current time. Often, users want the presented times of the various devices to be synchronized. A user may not want three clocks in a kitchen area presenting three different times. Unfortunately, conventional resetting techniques do not facilitate the synchronization of multiple home based electronic devices.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 presents a flow diagram for a process that facilitates network assisted and transparent adjustment of a home network node timing component utilizing teachings of the present disclosure;

FIG. 2 shows one embodiment of a distributed system that incorporates teachings of the present disclosure to transparently adjust the timing components of multiple home network nodes; and

FIG. 3 shows one embodiment of a portal system that incorporates teachings of the present disclosure to facilitate network-assisted adjustment of home network node timing components.

### DETAILED DESCRIPTION OF THE DRAWINGS

A network may be characterized by several factors like who can use the network, the type of traffic the network carries, the medium carrying the traffic, the typical nature of the network's connections, and the transmission technology the network uses. For example, one network may be public and carry circuit switched voice traffic while another may be private and carry packet switched data traffic. Whatever the make-up, most networks facilitate the communication of information between at least two nodes, and as such act as communication networks.

At a physical level, a communication network may include a series of nodes interconnected by communication paths. One or more of these nodes may act as an aggregation point. Several devices and/or nodes may connect to the aggregation point and “share” the aggregation point's backhaul connection. Depending on implementation detail, the aggregation point may “hide” the identity of the devices sharing its connection. For example, in a home network utilizing a wireless router/modem device as the home aggregation point, other home network nodes may be invisible to the wide area network (WAN) to which the home aggregation point connects.

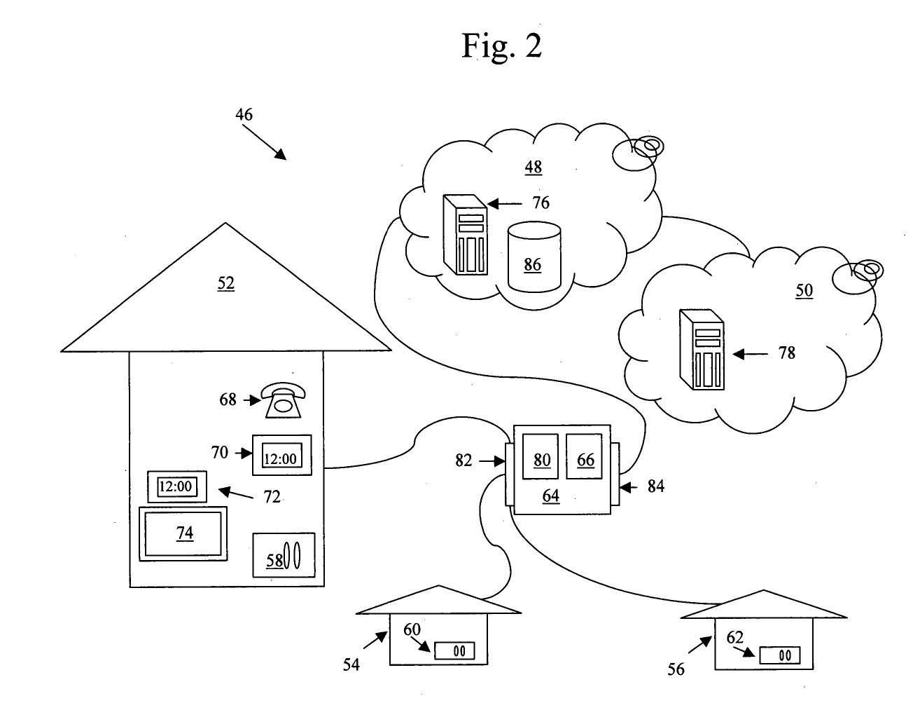

From a high level, a system like the one depicted in FIG. 2 may include a device or collection of devices capable of acting as a home aggregation point or communication portal. The portal system may include a modem, a processor, a memory, and may perform router like functions, web server functions, and/or NTP server functions. The portal system may be a single integrated device or a collection of related devices including discrete components, and/or integrated components.

In the following discussion, the portal system may be referred to and/or embody a router, an aggregation point, a router-like device, and/or some other appropriate mechanism having capabilities such as modem capabilities and processing capabilities. The portal may bridge or interconnect a LAN with a WAN, Metropolitan Area Network (MAN), or other network. In effect and as shown in FIG. 2, the portal may represent a point of demarcation between a home network and a broader network communicatively connected to the home network.

In one embodiment, a portal incorporating teachings of the present disclosure may include a housing component at least partially defining an external surface and an internal cavity. A broadband modem component may be at least partially located within the internal cavity along with a home networking mechanism, which may be communicatively coupled to the broadband modem. In operation, the home networking mechanism may facilitate providing other home network nodes with access to a backhaul enabled by the broadband modem. A processor may also be located within the internal cavity and may be communicatively coupled to the broadband modem and to a memory. In some embodiments, the memory may store instructions that direct the processor to, among other things, embody a web server, perform routing functions, receive a timing signal from a remote Public Internet time code protocol server, and communicate time information representing the timing signal to other home network nodes via the home networking mechanism.

Embodiments discussed below describe, in part, solutions for realizing a network-assisted and transparent adjustment of home network node timing components. Facilitating such a solution may involve a Public Internet time code protocol like Network Time Protocol (NTP). One form of NTP, which may be utilized to embody teachings disclosed herein, is defined in Request for Comments 1305 (RFC-1305). In operation, a piece of NTP (RFC-1305) client software may run on a portal acting as a home network router. The NTP client may run as a background task that periodically gets updates from one or more WAN nodes acting as an NTP server. Such a client may be configured to collect timing information from multiple sources. If the received information is inconsistent, the client may need to determine which time is “accurate” and/or perform some amount of averaging. In some embodiments, an executing NTP client may be configured to send a single timing request to a single server and rely on that server's response to set clocks. Such a simple client may be referred to as an SNTP client (Simple Network Time Protocol).

In operation of a system like the one depicted in FIG. 2, a local NTP client executing at a home network node may receive timing information as a 32-bit unformatted binary number that represents the time in Coordinated Universal Time (UTC). The timing information may represent time in hours, minutes, and seconds (HH:MM:SS) and may include an offset to be applied to the UTC time to account for local time adjustments. For example, Central Time in the United States may be six hours behind UTC during Standard Times and five hours behind during Daylight Saving Time. In some embodiments, actual local time adjustments may be made at a service provider network node, an NTP server, and/or at a client. Depending on implementation detail, NTP server responses may have a TCP/IP and/or a UDP/IP format.

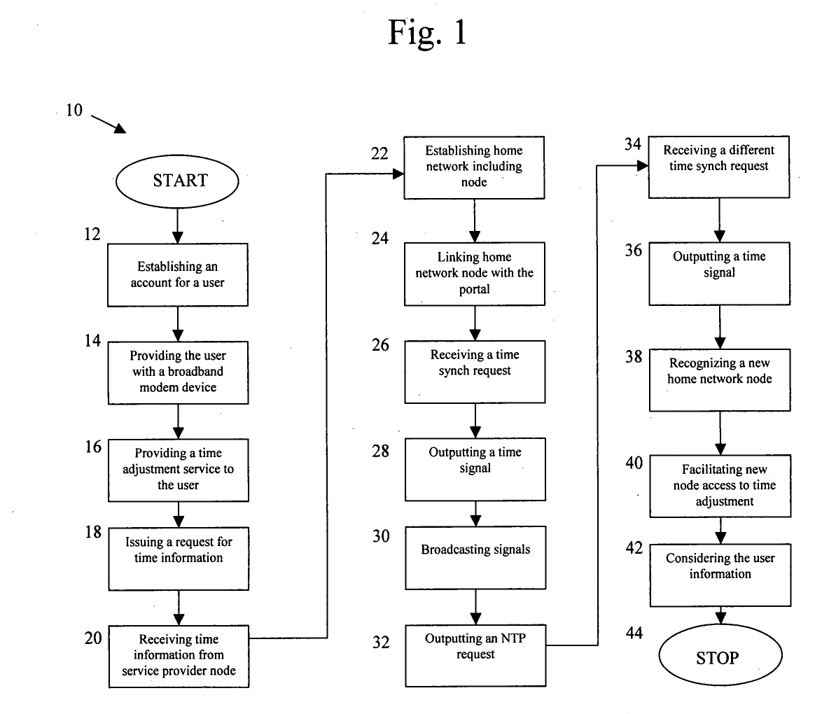

Transparent clock management may be better understood by reference to the Figures. As mentioned above, FIG. 1 presents a flow diagram for a process 10 that facilitates network-assisted and transparent adjustment of a home network node timing component utilizing teachings of the present disclosure. At step 12, a new user may contact a service provider requesting a subscription to a network assisted time adjustment service. In some embodiments, the user may already enjoy a broadband data service provided by the service provider. The broadband service may be a wireline broadband option like Asynchronous Digital Subscriber Line (ADSL), some other form of Digital Subscriber Line technology (xDSL), and/or a cable modem-based offering. The service may also include a fiber-based offering like Fiber to the Home (FTTH) and Passive Optical Networking (PON) and/or a wireless option like wireless local loop (WLL), fixed wireless such as MMDS or LMDS, and/or a satellite-based offering.

Whatever the underlying technology and backhaul, the network-assisted time adjustment service account may be established at step 12. At step 14, the subscriber/user may be provided with a portal, which may be incorporated into a device having wireline, powerline, and/or wireless router-like capabilities. In some embodiments, the portal may support the establishment of a home networking LAN. Multiple pieces of Customer Premises Equipment (CPE) may be capable of sharing the broadband connection supported by a modem device included in the portal. Example pieces of CPE may include home appliances, kitchen appliances, consumer electronic devices, computers, microwave ovens, conventional ovens, video recorders, alarm clocks, air conditioning systems, heating systems, alarm systems, and Voice over Internet Protocol (VoIP) telephones.

Depending on implementation detail, a provided portal may be capable of embodying a home networking mechanism, a web server, and/or an NTP server. The portal may perform routing functions, may receive a timing signal from a remote Public Internet time code protocol server, and may communicate time information representing the timing signal to other home network nodes via the home networking mechanism.

In some embodiments, a user may already have a programmable router/modem device, and the service provider may provide the user with software to upgrade the device—adding time adjustment capabilities. Providing the software may involve, for example, making the software available for download via the web and/or providing the user with a disk or other medium storing time adjustment instructions.

At step 16, the user may have “plugged in” the portal and initiated a broadband connection with a node of the service provider network. In some cases, the service provider network node may be acting as an access concentrator—providing high speed access to many different portals at the same time. The access concentrator may be, for example, a digital subscriber line access multiplexer (DSLAM), some other telephone network node, a cable modem termination system (CMTS), some other piece of cable head end equipment, some other cable network node, and/or some other component capable of supporting communication with the modem device. Whatever its form, the access concentrator may “know” that the portal desires connectivity, because the modem device issued a request for connection.

For example, the provided portal may be executing a Point to Point over Ethernet client capable of initiating establishment of a PPP session. The portal may also be executing an NTP client that requests, at step 18, time information from a service provider network node, which may be part of a wide area network (WAN) like the Public Switched Telephone Network (PSTN), a cable network, a Public Internet, etc. The WAN node may be operating as an NTP server and may be maintaining time information that represents a Coordinated Universal Time value. In practice, the time value may have come to the WAN node from other higher level NTP servers, a satellite, and/or other appropriate source. Whatever its origin, the WAN node may output an IP packet to the portal at step 20. The IP packet may include at least a partial representation of the time information maintained at the WAN node.

At step 22, the user may have established a home network that includes the portal as a hub. For example, the home network may be a wireless home network facilitated by an 802.11(x) wireless router associated with or embodied in the portal. At step 24, a collection of IP-enabled home network devices may be communicatively linked with the portal via the wireless router. Several of these devices may have a clock or other time keeping mechanism (Clock). In preferred embodiments, these Clocks may be effectively programmed and/or adjusted remotely.

For example, a user may own an IP-enabled alarm clock running its own NTP client. This alarm clock may represent one piece of CPE linked to the portal at step 24. At some point, power may be lost to the premises, and the alarm clock may resultantly “lose track of time” and begin displaying a blinking twelve when power is restored. As part of a power-up sequence, the NTP client executing at the alarm clock may, as indicated at step 26, send a request to the portal or a server executing on the portal for time synchronization.

In response to this request and at step 28, the portal may output a time signal to the alarm clock via the home network. Depending on implementation detail, the alarm clock may effectively “HTTP” its way to the portal, and the portal may be “listening” for synchronization requests with an HTTP daemon. In addition to responding to time synch queries, the portal may occasionally broadcast time signals at step 30. A broadcasting approach may help to ensure that the various displayed clocks of a premises show the same time.

At step 32, the portal may request time information from one or more WAN nodes. This requesting may occur sporadically and/or at regular intervals. In some circumstances, a regular tuning of time information maintained at the portal may be preferred. For example, if a VoIP telephone station operates as a home network node in a home network facilitated by the portal, accurate time keeping may improve voice call quality. If the VoIP telephone is in time with WAN nodes, overly late VoIP packets may be more accurately recognized in-network and dropped.

As such, a VoIP telephone included within the subscriber's home network may, at step 34, issue a time synch request, and the portal may respond at step 36. The number and type of home network nodes utilizing the time adjustment/management service may vary by subscriber. In preferred embodiments, the portal may include a “find” feature that allows the portal to recognize, at step 38, when a new IP-enabled device enters the home network. Depending on home network design, the new device may be assigned a private or LAN-side IP address and may be “told”, at step 40, that the portal acts as an NTP server for the home network. If the new device has a clock and/or needs time adjustment, the new device may merely need to HTTP its way to the NTP server executing at the portal.

A service provider facilitating a network supported time adjustment service may do so at no cost and/or at some appropriate cost. At step 42, the service provider may consider a repository of subscriber-related information to determine if a given subscriber is utilizing the service. The service provider may elect to generate an invoice at least partially based on the information, and may submit the invoice to the subscriber.

In practice, process 10 may continue, may loop, and/or proceed to stop at step 44. Individual steps of process 10 may be amended, re-ordered, added, and/or deleted without departing from the teachings. In addition, the party or device performing various steps may be altered as well to make effective use of available resources within a system implementing some or all of process 10.

As mentioned above, FIG. 2 shows one embodiment of a distributed system 46 that incorporates teachings of the present disclosure to facilitate centralized clock setting of multiple LAN-side devices. In operation, end users may connect to a service provider network 48 and/or an information network 50, like the Public Internet, an Intranet, an Extranet, some other communication network, and/or some combination thereof. As shown, system 46 includes several premises 52, 54, and 56, each having its own portal device 58, 60, and 62, respectively.

In practice, various pieces of CPE located at premises 52 may be networked with portal 58, which may be capable of communicatively coupling to service provider network 48. Network 48 may include, for example, a Public Switched Telephone Network (PSTN), a cable network, some xDSL infrastructure, a wireless network, and/or some other networking components capable of facilitating data communication. Whatever its make up, network 48 may be capable of communicating information. The communication could occur, for example, across dedicated circuits, as IP packets, and/or across an air interface. As depicted, a modem associated with portal 58 may communicate with and/or through a facility 64 of network 48. Facility 64 may be, for example, a remote terminal (RT) site, a central office, a cable head end, or some other provider facility. As such, facility 64 may include network nodes like access concentrator 66, which may include a DSLAM or a CMTS for example.

In operation, several devices at premises 52 may have time keeping mechanisms. For example, VoIP telephone 68, clock 70, video recorder 72, and/or television 74 may include programmable clocks. In preferred embodiments, these pieces of CPE may be IP-enabled and may include an SNTP client capable of querying portal 58 for a time signal representing a current and accurate time. Depending on design, a given piece of CPE like clock 70 may include a self-setting feature capable of using the time signal requested by the SNTP client.

For example, clock 70 may recognize a recent loss of power at premises 52 and may attempt self-setting when power is restored. As part of this process, an internal self-setting feature may prompt a local SNTP client to gather a current and accurate time from portal 58. The SNTP client may pass this information to the self-setting feature and clock 70 may be accurately reset without user intervention. Such a process may save user time, in addition to allowing for quick, easy, and accurate clock setting. The process may also help keep clock-related traffic on the LAN-side of portal 58—saving backhaul bandwidth for other services.

As mentioned above, various pieces of CPE may utilize time information maintained at portal 58, and a resident of premises 52 may subscribe to a time adjustment service offered by a service provider managing network 48. In practice, portal 58 may communicate with a network node like server 76 via access concentrator 66. Portal 58 may effectively “ask” server 76 “what time is it?” In the depicted embodiment, server 76 may be an NTP server, may “know” what time it is, and may share this knowledge with portal 58. In fact, server 76 may be part of a larger hierarchy of NTP servers and, as such, may communicate with another NTP server 78, which may be a primary server.

A primary server or stratum 1 server may be implemented at a computer connected to a reference clock. Connected to a stratum 1 server may be servers like server 76 or stratum 2 servers, which may periodically and/or automatically query the primary server to synchronize their system clocks. The stratum 2 servers may synchronize other computers, stratum 3 devices, and so on. As one moves from stratum 1 devices to lower stratum devices, the synchronization accuracy may decrease. To combat this tendency, a given client may be configured to have more the one server in the upper stratum. The client may monitor the accuracy of the upper stratum servers and dynamically elect to rely on the one server that appears to be the most accurate.

A service provider may elect to install and configure NTP software on a portal prior to providing the portal to a user. The pre-install/configuration process may allow the service provider to simplify the user's experience in implementing an NTP client and a non-primary NTP server at portal 58. Similarly, various pieces of CPE at premises 52 may be remotely loaded with NTP clients that are configured to “ask” portal 58 (or a web/NTP server executing at portal 58) for the current time.

Though servers 76 and 78 are shown as stand alone computing systems, some portion of their respective functionality may be implemented by other network nodes like access concentrator 66 and/or a computing platform 80 associated with access concentrator 66. In the embodiment of FIG. 2, access concentrator 66 may have an associated computing platform 80 and an interface 82 that facilitates the communicative coupling of portals 58, 60, and 62 to computing platform 80. Access concentrator 66 may also include a second interface 84 that facilitates an outputting of a collection of information representing packets received, for example, via portal 58 and portal 60.

In some embodiments, computing platform 80 may at least partially embody multiple engines performing various functions. For example, platform 80 may execute computer readable instructions to embody an NTP server, to embody an NTP client, and/or to maintain and manage a repository 86 storing information about subscribers. In some cases, the stored information may indicate that a given user subscribes to a remote time adjustment service. If a portal device like portal 58 requests updated time information, repository 86 may be considered to ensure that the resident of premises 52 subscribes to the service.

In addition and/or in lieu of the above-mentioned functions, platform 80 may execute computer readable instructions to embody a billing engine. Platform 80 may consider a pattern of use and/or subscription related information in connection with generating an invoice for the subscriber, and include a charge in a user's invoice for utilization of a remote time adjustment service. The charge may be a flat rate fee and/or a per use fee.

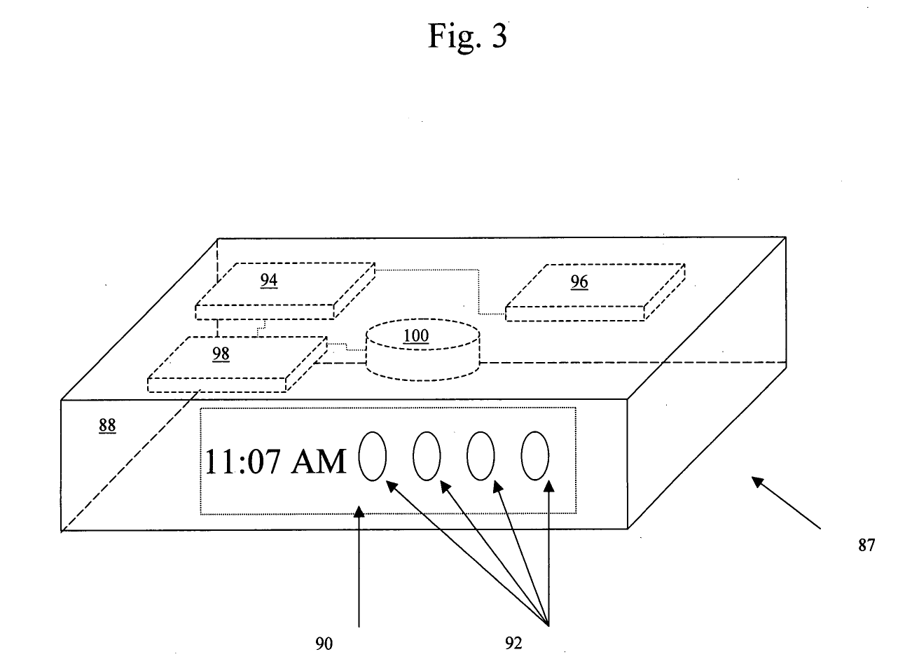

As mentioned above, FIG. 3 shows one embodiment of a portal system 87 that incorporates teachings of the present disclosure to facilitate network assisted adjustment of a home network node timing components. As shown, portal 87 includes a housing component 88 and a user interface 90 coupled thereto. User interface 90 includes a collection of visual display portions 92. Display portions 92 may be embodied as individual LEDs, indicators, locations on a screen display, and/or some other embodiment capable of communicating some information to a user. In preferred embodiments, display portions 92 may include a presentation of what portal 87 believes to be the current time.

As shown, a housing component 88 may at least partially define an external surface and an internal cavity. A broadband modem component 94 may be at least partially located within the internal cavity along with a home networking mechanism 96, which may be communicatively coupled to broadband modem 94. In operation, home networking mechanism 96 may facilitate providing other home network nodes with access to a backhaul enabled by broadband modem 94. A processor 98 may also be located within the internal cavity and may be communicatively coupled to broadband modem 94 and to a memory 100, which may be local, remote, removable, fixed, flash, non-volatile random access, and/or some other appropriate form of memory. In some embodiments, memory 100 may store instructions that direct processor 98 to, among other things, embody a web server, perform routing functions, receive a timing signal from a remote Public Internet time code protocol server, and communicate time information representing the timing signal to other home network nodes via home networking mechanism 96.

Communication between a portal system like portal 87 and a node of a WAN network may take several forms. Communication may occur across dedicated circuits, in a packetized manner, across virtual connections, in a special data frequency band, across a wireline connection including copper, optical fiber, coaxial fiber, an air interface, and/or a combination thereof. Similarly and as depicted in FIG. 2, communication between a portal 58 and a clock 70 or a video recorder 72 may take several forms. There may be a physical link of copper, coax, fiber, etc. There may also be an air interface that utilizes Radio Frequency (RF) communication. As such, devices like video recorder 72 and portal 58, both of FIG. 2, may be capable of Radio Frequency communication with one another and with other nodes via a Wireless LAN using a short-range or local wireless technology like 802.11, Wi-Fi, Bluetooth, and/or some other technique.

It should be understood that the mechanisms, computers, devices, engines, servers, and/or platforms, described herein, may take several different forms and may be stand alone and/or incorporated into several different pieces of equipment, like laptop computers, desktop computers, telephones, mainframes, PSTN switches, Ethernet switches, routers, gateways, hardware, firmware, software, work stations, other options having some level of computing capability, and/or a combination thereof. For example, various engines could be independent applications, could be independent servers, could be executing on different platforms, and/or could be executing on a single platform.

The methods and systems described herein provide for an adaptable implementation. Although certain embodiments have been described using specific examples, it will be apparent to those skilled in the art that the invention is not limited to these few examples. Note also, that although certain illustrative embodiments have been shown and described in detail herein, along with certain variants thereof, many other varied embodiments may be constructed by those skilled in the art.

The benefits, advantages, solutions to problems, and any element(s) that may cause any benefit, advantage, or solution to occur or become more pronounced are not to be construed as a critical, required, or essential feature or element of the present invention. Accordingly, the present invention is not intended to be limited to the specific form set forth herein, but on the contrary, it is intended to cover such alternatives, modifications, and equivalents, as can be reasonably included within the spirit and scope of the invention as provided by the claims below.

1. A method of clock setting comprising:
receiving a time synchronization request at a home network node comprising a web server; and
outputting a time signal to a requesting device via a home network, the requesting device comprising a different node of the home network.

2. The method of claim 1, wherein the home network node further comprises a Network Time Protocol (NTP) server.

3. The method of claim 1, wherein the home network node further comprises a broadband modem.

4. The method of claim 1, wherein the home network node further comprises a router, further comprising establishing the home network with the router.

5. The method of claim 4, wherein the router comprises a wireless router embodying an 802.11(x) access point.

6. The method of claim 1, further comprising receiving at the home network node a network timing signal via a digital subscriber line access multiplexer.

7. The method of claim 1, further comprising receiving at the home network node a network timing signal via a cable modem termination system.

8. The method of claim 1, wherein the different node comprises a piece of Internet Protocol enabled Customer Premises Equipment (IP-enabled CPE).

9. The method of claim 8, wherein the IP-enabled CPE is selected from a group consisting of a telephone, a clock, a kitchen appliance, a television, a game console, and a Set Top Box (STB).

10. The method of claim 1, further comprising utilizing a Hypertext Transfer Protocol daemon to respond to the time synchronization request.

11. The method of claim 1, further comprising:
recognizing the time synchronization request with a Hypertext Transfer Protocol daemon;
accessing information from a Network Time Protocol (NTP) server executing at the home network node, the information representing a Coordinated Universal Time value; and
including a representation of the information in the time signal.

12. The method of claim 11, further comprising utilizing a modem device associated with the home network node to request a network timing signal from a remote NTP server.

13. The method of claim 11, further comprising:
receiving another time synchronization request at the home network node; and
outputting another time signal to a different requesting device via the home network, the different requesting device comprising another node of the home network.

14. A time adjustment system, comprising:
a housing component at least partially defining an external surface and an internal cavity;
a broadband modem component at least partially located within the internal cavity;
a home networking mechanism at least partially located within the internal cavity and communicatively coupled to the broadband modem, the home networking mechanism operable to facilitate providing a home network node with access to a backhaul enabled by the broadband modem;
a processor at least partially located within the internal cavity and communicatively coupled to the broadband modem and to a memory; and
the memory comprising instructions operable to direct the processor to embody a web server, to receive a timing signal from a remote Public Internet time code protocol server, and to communicate time information representing the timing signal to the home network node via the home networking mechanism.

15. The system of claim 14, further comprising a network operator access concentrator communicatively coupled to the broadband modem and operable to pass the timing signal.

16. The system of claim 15, wherein the access concentrator comprises a digital subscriber line access multiplexer.

17. The system of claim 15, wherein the access concentrator comprises a cable modem termination system.

18. The system of claim 14, further comprising the home network node, wherein the home network node comprises a Voice over Internet Protocol (VoIP) telephone.

19. The system of claim 14, further comprising the home network node, wherein the home network node comprises a clock.

20. The system of claim 14, further comprising the home network node, wherein the home network node comprises an oven.

21. The system of claim 14, further comprising the home network node, wherein the home network node comprises a piece of Internet Protocol enabled consumer electronic equipment.

22. The system of claim 14, wherein the home networking mechanism comprises an 802.11(x) wireless networking access point.

23. The system of claim 14, wherein the broadband modem comprises an xDSL modem.

24. The system of claim 14, wherein the broadband modem comprises a cable modem.

25. The system of claim 14, further comprising a plurality of home network nodes.

26. The system of claim 25, wherein the memory comprises instructions operable to direct the processor to broadcast the time information to the plurality of home network nodes.

27. The system of claim 14, further comprising a Hypertext Transfer Protocol daemon operable to receive a request for the time information from the home network node.

28. A method of adjusting a remote time keeping device, comprising:
making a remote time adjustment service available to a subscriber of a broadband data service;
communicatively coupling a service provider network node with a piece of customer premises equipment (CPE) associated with the subscriber, the piece of CPE comprising a broadband modem device;
receiving a request for time information communicated from the piece of CPE via a broadband communication link at least partially interconnecting the service provider network node and the piece of CPE;
maintaining time information representing a Coordinated Universal Time value in a memory; and
outputting an Internet Protocol (IP) packet via the broadband communication link, the IP packet comprising at least a partial representation of the time information.

29. The method of claim 28, further comprising providing the subscriber with the piece of CPE, the piece of CPE comprising a service provider network interface and a home network interface, the piece of CPE further comprising a Hypertext Transfer Protocol (HTTP) daemon operable to receive a home network request for time adjustment information from a home network node via the home network interface.

30. The method of claim 29, wherein the piece of CPE is an integrated home networking device comprising the broadband modem device, the HTTP daemon, a processor, a router, and a local area wireless transceiver.

31. The method of claim 30, further comprising a Point to Point over Ethernet client executing on the processor.

32. The method of claim 27, further comprising:
maintaining a repository comprising information about the subscriber, the information indicating that the subscriber subscribes to the remote time adjustment service;
considering the information in connection with generating an invoice for the subscriber; and
including a charge for the remote time adjustment service in the invoice.

33. The method of claim 27, further comprising making the remote time adjustment service available to a plurality of subscribers.

34. The method of claim 27, further comprising:
outputting a Network Time Protocol (NTP) request to a NTP server;
receiving a response from the NTP server including a different Coordinated Universal Time value; and
updating the time information in the memory to represent the different Coordinated Universal Time value.
